(19) United States
(12) Patent Application Publication
(10) Pub. No.: US 2021/0125210 A1
(43) Pub. Date: Apr. 29, 2021

(54) INCOME ESTIMATION FOR A SHORT-TERM RENTAL PROPERTY

(71) Applicant: Vacasa LLC, Portland, OR (US)

(72) Inventors: Kyle CHRISTENSEN, Portland, OR (US); James DiPADUA, Portland, OR (US); Travis GREEN, Portland, OR (US); Devin HANSEN, Portland, OR (US); Hannah SOMHEGYI, Portland, OR (US)

(21) Appl. No.: 17/083,070

(22) Filed: Oct. 28, 2020

Related U.S. Application Data
(60) Provisional application No. 62/927,610, filed on Oct. 29, 2019.

(51) Int. Cl. G06Q 30/02; G06Q 50/16; G06Q 30/06; G06N 5/04; G06K 9/00; G06F 40/40

(52) U.S. Cl. CPC G06Q 30/0205; G06Q 50/16; G06Q 30/0645; G06Q 10/02; G06N 5/04; G06K 9/00637; G06F 40/40; G06Q 30/0206

(57) ABSTRACT

A system is presented for estimating the potential short-term rental income of a target property. The system utilizes techniques such as natural language processing and image recognition to extrapolate meaningful data from public sources. Features of the target property and the associated geographic region are then extrapolated or inferred from the data, such that an average occupancy and average daily rate (ADR) are estimated. Estimated income can then be based on estimated occupancy and ADR.

### CROSS-REFERENCES

The following applications and materials are incorporated herein, in their entireties, for all purposes: U.S. Provisional Patent Application No. 62/927,610, filed Oct. 29, 2019.

### FIELD

This disclosure relates to systems and methods for estimating the income of rental properties. More specifically, the disclosed embodiments relate to estimating the expected income from listing a property on the short-term rental market.

### INTRODUCTION

Homeowners may be interested in first estimating the expected income of their property on the short-term rental market before deciding to officially list their property. The variability in the rental market often makes it difficult to produce a simple estimation, and the variability between individual properties can make estimation even more difficult.

### SUMMARY

The present disclosure provides systems, apparatuses, and methods relating estimating the income of a property or properties on the short-term rental market.

In some embodiments, a computer-implemented method may include: determining, from one or more data sources, a set of property features including amenities of a target property; determining a location of the target property based on the set of property features; utilizing the location of the target property to infer a set of geographic features associated with the location; identifying other properties having similar amenities and geographic features as the target property; and estimating an expected rental income of the target property based on historical rental data of the identified other properties.

In some embodiments, a data processing system may include: one or more processors; a memory; a software program configured to estimate an expected short-term rental income of a target property, the software program including a plurality of instructions executable by the one or more processors to: determine, from one or more data sources, a set of property features including amenities of the target property; determine a location of the target property based on the set of property features; utilize the location of the target property to infer a set of geographic features associated with the location; identify other properties having similar amenities and geographic features as the target property; and estimate the expected rental income of the target property based on historical rental data of the identified other properties.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a flow chart depicting steps of an illustrative method for estimating the income of a short-term rental property in accordance with the present disclosure.

FIG. 2 is a is a flow chart depicting steps of an illustrative method for generating a vacation score in accordance with the present disclosure.

FIG. 3 is a schematic diagram depicting an illustrative data processing system.

FIG. 4 is a schematic diagram depicting an illustrative network data processing system.

### DETAILED DESCRIPTION

Various aspects and examples of a system for estimating the expected income of short-term rental properties are described below and illustrated in the associated drawings. Unless otherwise specified, an income estimator in accordance with the present teachings, and/or its various components, may contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

This Detailed Description includes the following sections, which follow immediately below: (1) Definitions; (2) Overview; (3) Examples, Components, and Alternatives; (4) Advantages, Features, and Benefits; and (5) Conclusion. The Examples, Components, and Alternatives section is further divided into subsections, each of which is labeled accordingly.

### Definitions

The following definitions apply herein, unless otherwise indicated.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“AKA” means “also known as,” and may be used to indicate an alternative or corresponding term for a given element or elements.

“Processing logic” means any suitable device(s) or hardware configured to process data by performing one or more logical and/or arithmetic operations (e.g., executing coded instructions). For example, processing logic may include one or more processors (e.g., central processing units (CPUs) and/or graphics processing units (GPUs)), microprocessors, clusters of processing cores, FPGAs (field-programmable gate arrays), artificial intelligence (AI) accelerators, digital signal processors (DSPs), and/or any other suitable combination of logic hardware.

“POI” means point of interest.

“ADR” means average daily rate.

In this disclosure, one or more publications, patents, and/or patent applications may be incorporated by reference. However, such material is only incorporated to the extent that no conflict exists between the incorporated material and the statements and drawings set forth herein. In the event of any such conflict, including any conflict in terminology, the present disclosure is controlling.

Overview In general, a system for estimating the income of a short-term rental property (the method and/or system is also referred to as an income estimator) analyzes characteristics of the property in question, and utilizes predictive models trained on characteristic data of the property, the geographic region, and nearby properties to estimate an expected occupancy and an expected income on the short-term rental market.

The characteristics of the property may include property features (e.g., bedrooms, bathrooms, amenities, etc.) and/or geographic features (e.g., neighborhood features, proximity to beachfront/parks, nearby nightlife, etc.). These characteristics may be directly provided (e.g., by the property owner) or inferred through natural language processing (NLP) of descriptions found, for example, in publicly available information sources (e.g., advertisements, real estate postings, etc.).

The inferring or inferencing of characteristics through natural language processing techniques may include supervised learning and classification (e.g., support vector machines, neural networks, etc.), unsupervised learning (e.g., feature extraction through convolutional signal processing), and/or semantic analysis (e.g., the skip-gram model, the continuous bag of words model, word embeddings, long short-term memory (LSTM), etc.) to analyze the text descriptions of the property. The NLP techniques may be utilized to infer amenities from the description. In some examples, the inferred amenities are utilized to estimate occupancy. For example, there may be descriptions of the property consistent with large family amenities (e.g., phrases such as “the kids will enjoy”, “large play area”, etc.), and the NLP techniques infers from these descriptions a higher expected occupancy due to large families.

In some examples, the property features contribute to expected changes in the occupancy due to seasonality. For example, there may be descriptions of the property from previous real estate postings that include descriptions consistent with having beach access (e.g., phrases such as “just a few steps away from the beach”, “great views of the ocean”, “enjoy the beachfront access”, etc.). The NLP techniques may infer from these descriptions a higher expected occupancy during the summer months.

Property features may also be inferred through image recognition techniques such as feature classification using convolutional neural networks (CNNs). Images of the property may be classified, in conjunction with the NLP techniques described above, to identify characteristics such as recent remodels, amenities, number of rooms, etc. These images may be directly provided (e.g., by the property owner or a representative) or retrieved from public postings. For example, a recent real estate posting may include images of a kitchen and an associate description including phrases such as “new kitchen”, “recently renovated”, etc. The income estimation method utilizes the images and description to infer a recent renovation that may increase the expected rental rate for a given occupancy.

The property features are utilized by the method to generate an expected occupancy score. For example, a property having both more amenities and more bedrooms than another property may have a higher expected occupancy. In some examples, occupancy refers to an expected number of guests on a reservation (e.g., a daily rental capacity of the target property). In some examples, occupancy refers to the likelihood that the target property will be occupied on a given date. The expected occupancy score may also be dependent on other properties in the region. For example, the average occupancy of nearby properties may be utilized in the income estimation method in generating the expected occupancy score.

In some examples, the location of the property is utilized in the income estimation method to identify geographic features. The location of the property may be inferred in the income estimation method in several ways. The NLP of property descriptions may be used to infer a general location (e.g., the descriptions may include phrases such as “ocean front”, “X blocks away from ______”, “great views of ______”, etc.). These descriptions may be utilized by the income generator to estimate a region (country, state, city, neighborhood, etc.) to varying degrees of accuracy depending on the detail of the description. For example, a description may include the phrases “great views of the ocean” and “only two blocks from the Santa Monica Pier,” indicating a possible location area within a single neighborhood.

Additionally, or alternatively, the description of amenities may determine feature parameters utilized to search a given local geographic area. Properties that match the descriptions (i.e., that share the feature parameters) are candidates for the inferred location. The description and images of the property may match those of a confirmable property. For example, a picture of the front of the property may match a picture from another public source such as a rental advertisement or a previous short-term rental listing. This may be utilized in the income estimation method to identify the location of the property more exactly.

In some examples, the geographic features of the property are determined by the location and utilized to generate a “vacation score” associated with the region around the property. The vacation score may be generated based on one or more geographic features. A higher vacation score may indicate an increased expected occupancy for the property. The geographic features may be categorized by type. In some examples, there are four types of geographic features: family-friendly activities, recreation sites, shopping and dining, and the rental market demand of the region. More, fewer, or different feature types may be utilized.

In some examples, the vacation score is determined by summing all the points of interest for each type over a given region. This results in the region having a density of points of interest for each feature type. The density value for each feature type is combined into a single weighted average for the region. The vacation score for the region is then assigned based on the weighted average.

The vacation score is a portion of an overall feature set. The overall features of the property and other similar properties are utilized to classify a unique block group fingerprint. From that classification, two things are caused to happen. First, the expected income can be directly estimated (e.g., averaging known income data from all the similar properties in the block group). Second, an occupancy and an average daily rate (ADR) can be estimated, then income can be estimated from occupancy multiplied by ADR. Further combinations and aggregations of the data may be performed. The estimated income may be presented in terms of daily income, weekly income, monthly income, seasonal income, and/or yearly income.

Aspects of the income estimation method may be embodied as a computer method, computer system, or computer program product. Accordingly, aspects of the income estimation method may take the form of an entirely hardware embodiment, an entirely software embodiment (including firmware, resident software, micro-code, and the like), or an embodiment combining software and hardware aspects, all of which may generally be referred to herein as a “circuit,” “module,” or “system.” Furthermore, aspects of the income estimation method may take the form of a computer program product embodied in a computer-readable medium (or media) having computer-readable program code/instructions embodied thereon.

Any combination of computer-readable media may be utilized. Computer-readable media can be a computer-readable signal medium and/or a computer-readable storage medium. A computer-readable storage medium may include an electronic, magnetic, optical, electromagnetic, infrared, and/or semiconductor system, apparatus, or device, or any suitable combination of these. More specific examples of a computer-readable storage medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, and/or any suitable combination of these and/or the like. In the context of this disclosure, a computer-readable storage medium may include any suitable non-transitory, tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, and/or any suitable combination thereof. A computer-readable signal medium may include any computer-readable medium that is not a computer-readable storage medium and that is capable of communicating, propagating, or transporting a program for use by or in connection with an instruction execution system, apparatus, or device.

Program code embodied on a computer-readable medium may be transmitted using any appropriate medium, including but not limited to wireless, wireline, optical fiber cable, RF, and/or the like, and/or any suitable combination of these.

Computer program code for carrying out operations for aspects of the system for estimating income of a short-term rental property may be written in one or any combination of programming languages, including an object-oriented programming language (such as Java, C++), conventional procedural programming languages (such as C), interpreted programming languages (such as Python), and functional programming languages (such as Haskell). Mobile apps may be developed using any suitable language, including those previously mentioned, as well as Objective-C, Swift, C#, HTML5, and the like. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), and/or the connection may be made to an external computer (for example, through the Internet using an Internet Service Provider).

Aspects of the income estimation method may be described below with reference to flowchart illustrations and/or block diagrams of methods, apparatuses, systems, and/or computer program products. Each block and/or combination of blocks in a flowchart and/or block diagram may be implemented by computer program instructions. The computer program instructions may be programmed into or otherwise provided to processing logic (e.g., a processor of a general purpose computer, special purpose computer, field programmable gate array (FPGA), or other programmable data processing apparatus) to produce a machine, such that the (e.g., machine-readable) instructions, which execute via the processing logic, create means for implementing the functions/acts specified in the flowchart and/or block diagram block(s).

Additionally or alternatively, these computer program instructions may be stored in a computer-readable medium that can direct processing logic and/or any other suitable device to function in a particular manner, such that the instructions stored in the computer-readable medium produce an article of manufacture including instructions which implement the function/act specified in the flowchart and/or block diagram block(s).

The computer program instructions can also be loaded onto processing logic and/or any other suitable device to cause a series of operational steps to be performed on the device to produce a computer-implemented process such that the executed instructions provide processes for implementing the functions/acts specified in the flowchart and/or block diagram block(s).

Any flowchart and/or block diagram in the drawings is intended to illustrate the architecture, functionality, and/or operation of possible implementations of systems, methods, and computer program products according to aspects of the income estimation method. In this regard, each block may represent a module, segment, or portion of code, which comprises one or more executable instructions for implementing the specified logical function(s). In some implementations, the functions noted in the block may occur out of the order noted in the drawings. For example, two blocks shown in succession may, in fact, be executed substantially concurrently, or the blocks may sometimes be executed in the reverse order, depending upon the functionality involved. Each block and/or combination of blocks may be implemented by special purpose hardware-based systems (or combinations of special purpose hardware and computer instructions) that perform the specified functions or acts.

### Examples, Components, and Alternatives

The following sections describe selected aspects of exemplary systems for estimating the income of a short-term rental property as well as related systems and/or methods. The examples in these sections are intended for illustration and should not be interpreted as limiting the scope of the present disclosure. Each section may include one or more distinct embodiments or examples, and/or contextual or related information, function, and/or structure.

### A. Illustrative Method for Estimating the Income of a Short-Term Rental Property

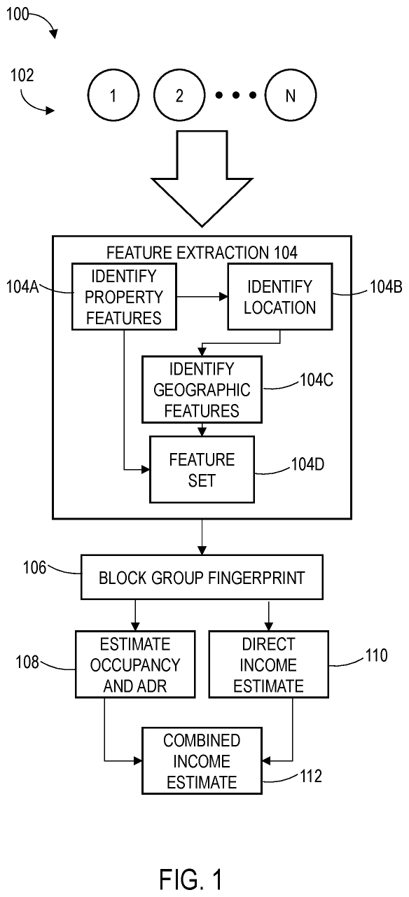

This section describes steps of an illustrative method 100 for estimating the income of a short-term rental property (AKA target property); see FIG. 1. Aspects of the income estimator described in the Overview above may be utilized in the method steps described below. Where appropriate, reference may be made to components and systems that may be used in carrying out each step. These references are for illustration, and are not intended to limit the possible ways of carrying out any particular step of the method.

FIG. 1 is a flowchart illustrating steps performed in an illustrative method, and may not recite the complete process or all steps of the method. Although various steps of method 100 are described below and depicted in FIG. 1, the steps need not necessarily all be performed, and in some cases may be performed simultaneously or in a different order than the order shown.

As indicated at step 102, a plurality of data sources (labeled 1 through N) are identified for the target property. In some examples, the data sources comprise descriptions and images supplied by the target property owner and/or that person's representative. In some examples, the data sources comprise public postings such as real estate listings, rental advertisements, short-term rental advertisements, tax assessor records, etc. In some examples, such as a property having a limited number of data sources available (e.g., a new construction, homestead, etc.), the data sources may comprise only a single source.

At step 104, features of the target property are extracted (AKA learned/inferred) from the data sources. Step 104 comprises the following substeps:

At step 104A, property features of the target property are identified from the data sources identified in step 102. The target property features may include the size of the target property (e.g., square footage, number of total rooms, number of bedrooms, etc.), condition of the target property (e.g., recent remodels, cleanliness, etc.), and amenities (e.g., pool, game room, laundry, etc.). In some examples, the property features are identified from written descriptions, for example through the use of machine learning (e.g., natural language processing).

The natural language processing and machine learning techniques utilized in steps 104A includes the use of a predictive model (e.g., a skip-gram model) that feeds into a classifier (e.g., a random forest, support vector machine, etc.). The image recognition techniques may include a trained machine learning model for image classification (e.g., a convolutional neural network). The training data for the predictive model and the classifier may be retrieved from privately and publicly available descriptions of real estate properties, rental advertisements, and other descriptions of properties.

For natural language processing, a skip-gram model may be utilized to predict the context of a target word in descriptions of the target property. In this manner, the skip-gram model learns to predict common associations between target words and the context words that surround the target word. For training, the descriptions may be broken up into linguistic strings (e.g., sentences, phrases, etc.) and converted to training vectors (for example, through one hot encoding). A general dictionary may be similarly converted into vectors through one hot encoding, resulting in a list of vocabulary vectors. The training vectors contain both the target word and surrounding context words which can be further broken into an input vector (target word) and associated context vector (context words). The number of context words that surround the target word is called the context window and by changing the width of the context window, the learning rate is correspondingly changed.

The target word input vector is input into a neural network, e.g., having a single hidden layer and a single output layer. The hidden layer may compute the dot product of the input vector and a first matrix of weights resulting in a hidden layer vector. The hidden layer vector is then passed to the output layer. The output layer computes the dot product of the hidden layer vector and a second matrix of weights giving an output vector. The output vector is then passed through an activation function (e.g., the softmax function), resulting in a probability value for each vector in the list of vocabulary vectors. The vector having the highest probability is the predicted result vector. The result vector can then be compared to the context vector. If the predicted result vector is incorrect, backpropagation may be used to update the two weight matrices to attempt to minimize a loss function.

After training, the predictive model is able to compute the context of a target word. This is especially useful in extracting property features such as amenities from descriptions. For example, the language used in two different descriptions may vary widely, but the context (i.e., amenities) of the two descriptions may be similar.

The resulting context data from all the training data descriptions may be further classified by the classifier. In one example, a random forest may be used for classification. In another example, a support vector machine may perform a predictive analysis on the data set (such as through multidimensional regression) to identify a hyperplane (i.e., decision boundary) in the data. In other words, the classifier may produce localized clusters of features corresponding to different feature classes. For example, one feature class of properties may be properties that have a pool. In general, a property may have multiple identifying features and each property feature may be identified individually, in some examples, with a feature-specific model. In other words, there may be multiple models utilized for multiple independent property features.

At step 1048, the location of the target property is identified from the data sources identified in step 102. In some examples, the location is supplied directly by the target property owner. In some examples, the location is determined from descriptions and images found in the data sources identified in step 102, e.g., through the use of natural language processing techniques and image recognition techniques described above. In other words, the location of the target property may be inferred by the property features identified in step 104A. For example, the property features identified in step 104A may be used as feature parameters to search a geographic area to identify a property with matching property features. In other words, the feature class(es) of the target property (AKA property features) may classify the target property with a list of property features that match another, known property (with a known location) exactly—thus giving a high likelihood that the two properties are the same and therefore the location is identified.

With the location identified, the geographic region of the target property may be labeled, for example utilizing one of two metrics: by geographic unit (e.g., census block group) or by spatial indexing (e.g., Google's S2 library). Identifying a predefined geographic unit such as the census block group of the target property allows for easy searching of geographic features belonging to the census block group. The spatial indexing allows for identification of a more dynamic geographic region (i.e., adaptable size, adaptable number of properties, etc.) for searching for geographic features. For example, in Google's S2 library, the world is divided into a series of hierarchical, spatial decomposition cells of various sizes with a one dimensional, space-filling Hilbert curve enumerating (i.e., indexing) the space of each cell. This allows for simple and dynamic indexing, while preserving the spatial locality of properties having a close index value.

At step 104C, geographic features of the target property's location are identified. The geographic features may include nearby activities (e.g., shopping, dining, parks, etc.) and market value of the geographic region (e.g., average home value, rental rates, known occupancies, etc.). The nearby activities may be aggregated into a vacation score that may be associated with the region or associated with the target property specifically (i.e., the vacation score may be associated with the city, the neighborhood, the block, the individual property, etc.).

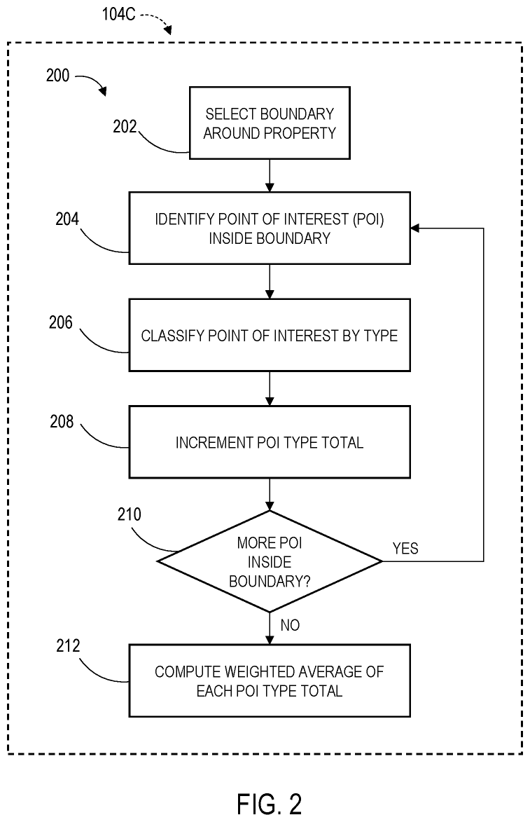

The geographic features of the target property can be identified for both the census block group and a local S2 index cell. The associated vacation score is identified from the geographic features of the target property. Identifying the vacation score of the target property is accomplished through searching the region for points of interest (see FIG. 2 and associate method 200 described below). The points of interest may be found from public data sources such as Google Maps, OpenStreetMap, etc. In addition to the vacation score, the geographic features of the target property may include the market value of other properties in the geographic region. The market value of these properties may be determined from public data sources such as tax assessor records, multiple listing service (MLS) records, etc.

At step 104D, a feature set for the target property is established. The feature set is an aggregate of both property features identified in step 104A and geographic features identified in step 104C.

At step 106, a block group fingerprint is determined by identifying a number of properties having a similar feature set as the target property. In other words, by processing a number of properties through the method steps described above, a collection of feature sets may be identified for a number of properties and the properties sharing a similar geographic location and similar property features are collectively referred to as the block group fingerprint. In other words, the block group fingerprint is an average feature set of properties expected to generate similar levels of income.

In some examples, determining the block group fingerprint includes identifying an occupancy ranking for the geographic region (e.g., the location found in step 104B) by ordering all of the short-term rental properties in the geographic region by occupancy rates (e.g., average daily occupancy, average weekly occupancy, average monthly occupancy, etc.). This ordering forms a distribution (e.g., a histogram) of rental properties and corresponding occupancy rates. The distribution may be separated into quartiles and the average occupancy associated with each quartile may be determined. Additionally, the separation into quartiles allows for the determination of the average historical ADR for each quartile. The quartile that the target property most closely related to is used to estimate the expected ADR. Additionally, changing how the property is marketed may change which quartile the property is most closely related to, thus estimating the impact of changing a marketing strategy of the property. The property features and geographic features that are associated with each quartile can be determined and grouped together as the block group fingerprint. The feature set of the target property may be compared to those of the identified block group fingerprints to determine which specific block group fingerprint the target property is most closely related.

At step 108, a first income estimate (AKA an indirect estimate) is determined by estimating an expected occupancy and average daily rate (ADR) of the target property. The expected occupancy and ADR is estimated from the block group fingerprint determined at step 106. The known occupancy rates, property features, and geographic features of the block group fingerprint can be utilized to form a ranking of occupancy levels dependent on the presence of certain features (e.g., amenities). The expected occupancy of the target property can be estimated from the average occupancy of the other properties sharing those certain features. For example, the neighborhood and set of amenities of the target property may match a group of other properties with known occupancy rates, thus giving a general expected occupancy based on that neighborhood and set of amenities.

The expected occupancy can be estimated from the average occupancy of other properties at the same, or similar, time of year—for example, by considering the occupancy of a property sharing similar features during a weekend in the summer. In some examples, the expected occupancy of a property is dependent on where it is being marketed (e.g., real estate listings, short-term rental listing, vacation home listings, etc.) and how it is being marketed (e.g., the variability in the set price). In some examples, the expected occupancy may be dependent on time of year (e.g., day, week, month, season, etc.).

The ADR may be determined by averaging the historical rates of other properties in the block group fingerprint. These may be determined as yearly averages, seasonal averages, monthly averages, weekly averages, or daily averages (e.g., to estimate the annual income of the target property, the yearly average ADR for similar properties may be multiplied by the yearly expected occupancy). Additionally, these may be weighted averages, wherein the weighting may be learned—for example, through the use of a neural network.

The first estimated income is determined by multiplying the expected occupancy and the ADR. This may also include a biasing correction. For example, if multiple properties contribute to an overall income distribution with a non-zero average error, the bias correction may move the average error to zero, thus increasing accuracy.

At step 110, a second income estimate of the target property (AKA a direct estimate) is determined by taking an average of the income of the other properties in the block group fingerprint. In some examples, the direct estimate is a yearly income estimate, e.g., by determining an average yearly income of all the properties in the block group fingerprint.

At step 112, a combined income estimate is determined by combining the first income estimate determined at step 108 with the second income estimate determined at step 110. In some examples, the combined income estimate is determined by a simple average. In some examples, the combined income estimate is determined by a weighted average.

One or more of the income estimates determined in method 100 (i.e., the first income estimate, the second income estimate, and/or the combined income estimate) may be provided (e.g., as a service) to an interested party. For example, the income estimates may be utilized to provide a current owner of the target property an estimate of income potential on the short-term rental market. In some examples, the income estimates are utilized to provide a potential purchaser of the target property an estimate of income potential on the short-term rental market.

In some examples, one or more of the income estimates determined in method 100 are utilized in a financial analysis of the target property. For example, the income estimates may be utilized in a broker price opinion of the target property. In some examples, the income estimates may be utilized in a rental market analysis of the target property. In some examples, the income estimates are aggregated and analyzed for a plurality of target properties in a geographical area or for any other suitable set of target properties.

FIG. 2 is a flowchart illustrating steps performed in an illustrative method for determining the vacation score of a property and may not recite the complete process or all steps of the method. Although various steps of method 200 are described below and depicted in FIG. 2, the steps need not necessarily all be performed, and in some cases may be performed simultaneously or in a different order than the order shown.

At step 202, a geographic boundary is selected around the target property. This may be, for example, the census block group or a local S2 cell.

At step 204, a point of interest (POI) is identified inside the boundary.

At step 206, the POI is classified by POI type (e.g., family-friendly, recreation, urban/culture).

At step 208, a POI type total corresponding to the POI type is incremented. In other words, there may be a counter for each POI type that keeps track of the total number of POIs of each respective type. In some examples, one POI of a given type may contribute more to the POI type total than another POI in the same type. For example, a popular restaurant may contribute more to its POI type total than a less popular restaurant.

At step 210, a determination is made regarding whether more POIs are present within the boundary. If so, return to step 204, if not continue to step 212.

At step 212, a weighted average of each POI type is computed. The average is weighted to allow for one POI type to contribute more to the total than another POI type. In some examples, the weights may all be the same, resulting in a normal average.

The vacation score of the target property is assigned according to the weighted average. In some examples, the vacation score may be the weighted average directly. In another example, the vacation score may be the weighted average normalized to a specific range (i.e., 0-1, 1-10, etc.).

### B. Illustrative Data Processing System

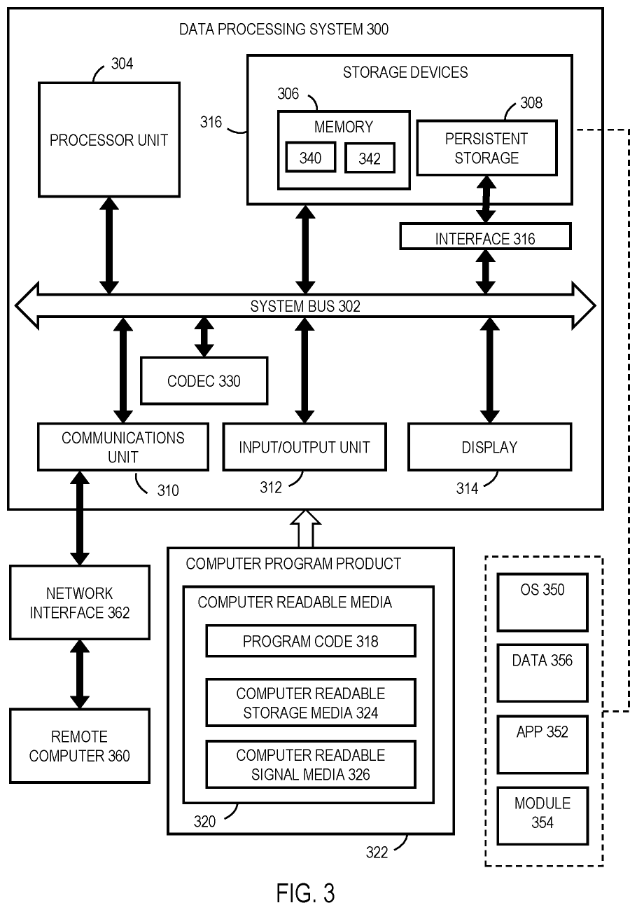

As shown in FIG. 3, this example describes a data processing system 300 (also referred to as a computer, computing system, and/or computer system) in accordance with aspects of the present disclosure. In this example, data processing system 300 is an illustrative data processing system suitable for implementing aspects of the income estimation method. More specifically, in some examples, devices that are embodiments of data processing systems (e.g., smartphones, tablets, personal computers) may process any combination of steps described in the methods above.

In this illustrative example, data processing system 300 includes a system bus 302 (also referred to as communications framework). System bus 302 may provide communications between a processor unit 304 (also referred to as a processor or processors), a memory 306, a persistent storage 308, a communications unit 310, an input/output (I/O) unit 312, a codec 330, and/or a display 314. Memory 306, persistent storage 308, communications unit 310, input/output (I/O) unit 312, display 314, and codec 330 are examples of resources that may be accessible by processor unit 304 via system bus 302.

Processor unit 304 serves to run instructions that may be loaded into memory 306. Processor unit 304 may comprise a number of processors, a multi-processor core, and/or a particular type of processor or processors (e.g., a central processing unit (CPU), graphics processing unit (GPU), etc.), depending on the particular implementation. Further, processor unit 304 may be implemented using a number of heterogeneous processor systems in which a main processor is present with secondary processors on a single chip. As another illustrative example, processor unit 304 may be a symmetric multi-processor system containing multiple processors of the same type.

Memory 306 and persistent storage 308 are examples of storage devices 316. A storage device may include any suitable hardware capable of storing information (e.g., digital information), such as data, program code in functional form, and/or other suitable information, either on a temporary basis or a permanent basis.

Storage devices 316 also may be referred to as computer-readable storage devices or computer-readable media. Memory 306 may include a volatile storage memory 340 and a non-volatile memory 342. In some examples, a basic input/output system (BIOS), containing the basic routines to transfer information between elements within the data processing system 300, such as during start-up, may be stored in non-volatile memory 342. Persistent storage 308 may take various forms, depending on the particular implementation.

Persistent storage 308 may contain one or more components or devices. For example, persistent storage 308 may include one or more devices such as a magnetic disk drive (also referred to as a hard disk drive or HDD), solid state disk (SSD), floppy disk drive, tape drive, Jaz drive, Zip drive, flash memory card, memory stick, and/or the like, or any combination of these. One or more of these devices may be removable and/or portable, e.g., a removable hard drive. Persistent storage 308 may include one or more storage media separately or in combination with other storage media, including an optical disk drive such as a compact disk ROM device (CD-ROM), CD recordable drive (CD-R Drive), CD rewritable drive (CD-RW Drive), and/or a digital versatile disk ROM drive (DVD-ROM). To facilitate connection of the persistent storage devices 308 to system bus 302, a removable or non-removable interface is typically used, such as interface 328.

Input/output (I/O) unit 312 allows for input and output of data with other devices that may be connected to data processing system 300 (i.e., input devices and output devices). For example, input device 332 may include one or more pointing and/or information-input devices such as a keyboard, a mouse, a trackball, stylus, touch pad or touch screen, microphone, joystick, game pad, satellite dish, scanner, TV tuner card, digital camera, digital video camera, web camera, and/or the like. These and other input devices may connect to processor unit 304 through system bus 302 via interface port(s) 336. Interface port(s) 336 may include, for example, a serial port, a parallel port, a game port, and/or a universal serial bus (USB).

Output devices 334 may use some of the same types of ports, and in some cases the same actual ports, as input device(s) 332. For example, a USB port may be used to provide input to data processing system 300 and to output information from data processing system 300 to an output device 334. Output adapter 338 is provided to illustrate that there are some output devices 334 (e.g., monitors, speakers, and printers, among others) which require special adapters. Output adapters 338 may include, e.g. video and sounds cards that provide a means of connection between the output device 334 and system bus 302. Other devices and/or systems of devices may provide both input and output capabilities, such as remote computer(s) 360. Display 314 may include any suitable human-machine interface or other mechanism configured to display information to a user, e.g., a CRT, LED, or LCD monitor or screen, etc.

Communications unit 310 refers to any suitable hardware and/or software employed to provide for communications with other data processing systems or devices. While communication unit 310 is shown inside data processing system 300, it may in some examples be at least partially external to data processing system 300. Communications unit 310 may include internal and external technologies, e.g., modems (including regular telephone grade modems, cable modems, and DSL modems), ISDN adapters, and/or wired and wireless Ethernet cards, hubs, routers, etc. Data processing system 300 may operate in a networked environment, using logical connections to one or more remote computers 360. A remote computer(s) 360 may include a personal computer (PC), a server, a router, a network PC, a workstation, a microprocessor-based appliance, a peer device, a smart phone, a tablet, another network note, and/or the like. Remote computer(s) 360 typically include many of the elements described relative to data processing system 300. Remote computer(s) 360 may be logically connected to data processing system 300 through a network interface 362 which is connected to data processing system 300 via communications unit 310. Network interface 362 encompasses wired and/or wireless communication networks, such as local-area networks (LAN), wide-area networks (WAN), and cellular networks. LAN technologies may include Fiber Distributed Data Interface (FDDI), Copper Distributed Data Interface (CDDI), Ethernet, Token Ring, and/or the like. WAN technologies include point-to-point links, circuit switching networks (e.g., Integrated Services Digital networks (ISDN) and variations thereon), packet switching networks, and Digital Subscriber Lines (DSL).

Codec 330 may include an encoder, a decoder, or both, comprising hardware, software, or a combination of hardware and software. Codec 330 may include any suitable device and/or software configured to encode, compress, and/or encrypt a data stream or signal for transmission and storage, and to decode the data stream or signal by decoding, decompressing, and/or decrypting the data stream or signal (e.g., for playback or editing of a video). Although codec 330 is depicted as a separate component, codec 330 may be contained or implemented in memory, e.g., non-volatile memory 342.

Non-volatile memory 342 may include read only memory (ROM), programmable ROM (PROM), electrically programmable ROM (EPROM), electrically erasable programmable ROM (EEPROM), flash memory, and/or the like, or any combination of these. Volatile memory 340 may include random access memory (RAM), which may act as external cache memory. RAM may comprise static RAM (SRAM), dynamic RAM (DRAM), synchronous DRAM (SDRAM), double data rate SDRAM (DDR SDRAM), enhanced SDRAM (ESDRAM), and/or the like, or any combination of these.

Instructions for the operating system, applications, and/or programs may be located in storage devices 316, which are in communication with processor unit 304 through system bus 302. In these illustrative examples, the instructions are in a functional form in persistent storage 308. These instructions may be loaded into memory 306 for execution by processor unit 304. Processes of one or more embodiments of the present disclosure may be performed by processor unit 304 using computer-implemented instructions, which may be located in a memory, such as memory 306.

These instructions are referred to as program instructions, program code, computer usable program code, or computer-readable program code executed by a processor in processor unit 304. The program code in the different embodiments may be embodied on different physical or computer-readable storage media, such as memory 306 or persistent storage 308. Program code 318 may be located in a functional form on computer-readable media 320 that is selectively removable and may be loaded onto or transferred to data processing system 300 for execution by processor unit 304. Program code 318 and computer-readable media 320 form computer program product 322 in these examples. In one example, computer-readable media 320 may comprise computer-readable storage media 324 or computer-readable signal media 326.

Computer-readable storage media 324 may include, for example, an optical or magnetic disk that is inserted or placed into a drive or other device that is part of persistent storage 308 for transfer onto a storage device, such as a hard drive, that is part of persistent storage 308. Computer-readable storage media 324 also may take the form of a persistent storage, such as a hard drive, a thumb drive, or a flash memory, that is connected to data processing system 300. In some instances, computer-readable storage media 324 may not be removable from data processing system 300.

In these examples, computer-readable storage media 324 is a non-transitory, physical or tangible storage device used to store program code 318 rather than a medium that propagates or transmits program code 318. Computer-readable storage media 324 is also referred to as a computer-readable tangible storage device or a computer-readable physical storage device. In other words, computer-readable storage media 324 is media that can be touched by a person.

Alternatively, program code 318 may be transferred to data processing system 300, e.g., remotely over a network, using computer-readable signal media 326. Computer-readable signal media 326 may be, for example, a propagated data signal containing program code 318. For example, computer-readable signal media 326 may be an electromagnetic signal, an optical signal, and/or any other suitable type of signal. These signals may be transmitted over communications links, such as wireless communications links, optical fiber cable, coaxial cable, a wire, and/or any other suitable type of communications link. In other words, the communications link and/or the connection may be physical or wireless in the illustrative examples.

In some illustrative embodiments, program code 318 may be downloaded over a network to persistent storage 308 from another device or data processing system through computer-readable signal media 326 for use within data processing system 300. For instance, program code stored in a computer-readable storage medium in a server data processing system may be downloaded over a network from the server to data processing system 300. The computer providing program code 318 may be a server computer, a client computer, or some other device capable of storing and transmitting program code 318.

In some examples, program code 318 may comprise an operating system (OS) 350. Operating system 350, which may be stored on persistent storage 308, controls and allocates resources of data processing system 300. One or more applications 352 take advantage of the operating system's management of resources via program modules 354, and program data 356 stored on storage devices 316. OS 350 may include any suitable software system configured to manage and expose hardware resources of computer 300 for sharing and use by applications 352. In some examples, OS 350 provides application programming interfaces (APIs) that facilitate connection of different type of hardware and/or provide applications 352 access to hardware and OS services. In some examples, certain applications 352 may provide further services for use by other applications 352, e.g., as is the case with so-called “middleware.” Aspects of present disclosure may be implemented with respect to various operating systems or combinations of operating systems.

The different components illustrated for data processing system 300 are not meant to provide architectural limitations to the manner in which different embodiments may be implemented. One or more embodiments of the present disclosure may be implemented in a data processing system that includes fewer components or includes components in addition to and/or in place of those illustrated for computer 300. Other components shown in FIG. 3 can be varied from the examples depicted. Different embodiments may be implemented using any hardware device or system capable of running program code. As one example, data processing system 300 may include organic components integrated with inorganic components and/or may be comprised entirely of organic components (excluding a human being). For example, a storage device may be comprised of an organic semiconductor.

In some examples, processor unit 304 may take the form of a hardware unit having hardware circuits that are specifically manufactured or configured for a particular use, or to produce a particular outcome or progress. This type of hardware may perform operations without needing program code 318 to be loaded into a memory from a storage device to be configured to perform the operations. For example, processor unit 304 may be a circuit system, an application specific integrated circuit (ASIC), a programmable logic device, or some other suitable type of hardware configured (e.g., preconfigured or reconfigured) to perform a number of operations. With a programmable logic device, for example, the device is configured to perform the number of operations and may be reconfigured at a later time. Examples of programmable logic devices include, a programmable logic array, a field programmable logic array, a field programmable gate array (FPGA), and other suitable hardware devices. With this type of implementation, executable instructions (e.g., program code 318) may be implemented as hardware, e.g., by specifying an FPGA configuration using a hardware description language (HDL) and then using a resulting binary file to (re)configure the FPGA.

In another example, data processing system 300 may be implemented as an FPGA-based (or in some cases ASIC-based), dedicated-purpose set of state machines (e.g., Finite State Machines (FSM)), which may allow critical tasks to be isolated and run on custom hardware. Whereas a processor such as a CPU can be described as a shared-use, general purpose state machine that executes instructions provided to it, FPGA-based state machine(s) are constructed for a special purpose, and may execute hardware-coded logic without sharing resources. Such systems are often utilized for safety-related and mission-critical tasks.

In still another illustrative example, processor unit 304 may be implemented using a combination of processors found in computers and hardware units. Processor unit 304 may have a number of hardware units and a number of processors that are configured to run program code 318. With this depicted example, some of the processes may be implemented in the number of hardware units, while other processes may be implemented in the number of processors.

In another example, system bus 302 may comprise one or more buses, such as a system bus or an input/output bus. Of course, the bus system may be implemented using any suitable type of architecture that provides for a transfer of data between different components or devices attached to the bus system. System bus 302 may include several types of bus structure(s) including memory bus or memory controller, a peripheral bus or external bus, and/or a local bus using any variety of available bus architectures (e.g., Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI)).

Additionally, communications unit 310 may include a number of devices that transmit data, receive data, or both transmit and receive data. Communications unit 310 may be, for example, a modem or a network adapter, two network adapters, or some combination thereof. Further, a memory may be, for example, memory 306, or a cache, such as that found in an interface and memory controller hub that may be present in system bus 302.

### C. Illustrative Distributed Data Processing System

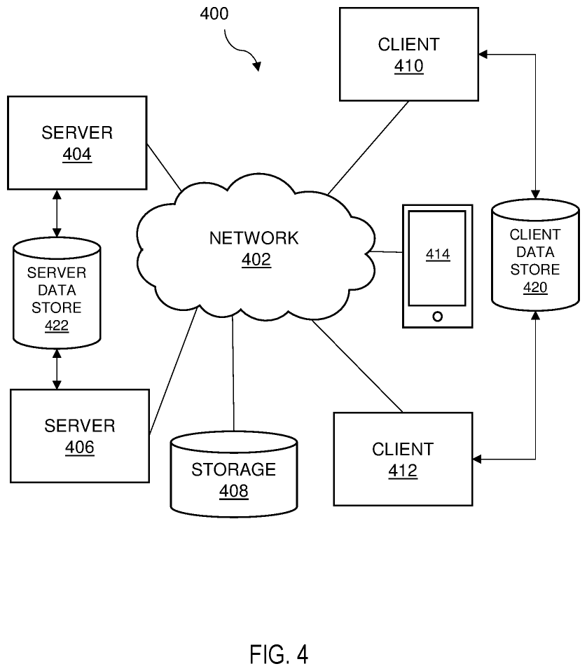

As shown in FIG. 4, this example describes a general network data processing system 400, interchangeably termed a computer network, a network system, a distributed data processing system, or a distributed network, aspects of which may be included in one or more illustrative embodiments of an income estimation method. For example, the NLP and/or image recognition techniques may be processed on a distributed data processing system utilizing network communication.

It should be appreciated that FIG. 4 is provided as an illustration of one implementation and is not intended to imply any limitation with regard to environments in which different embodiments may be implemented. Many modifications to the depicted environment may be made.

Network system 400 is a network of devices (e.g., computers), each of which may be an example of data processing system 300, and other components. Network data processing system 400 may include network 402, which is a medium configured to provide communications links between various devices and computers connected within network data processing system 400. Network 402 may include connections such as wired or wireless communication links, fiber optic cables, and/or any other suitable medium for transmitting and/or communicating data between network devices, or any combination thereof.

In the depicted example, a first network device 404 and a second network device 406 connect to network 402, as do one or more computer-readable memories or storage devices 408. Network devices 404 and 406 are each examples of data processing system 300, described above. In the depicted example, devices 404 and 406 are shown as server computers, which are in communication with one or more server data store(s) 422 that may be employed to store information local to server computers 404 and 406, among others. However, network devices may include, without limitation, one or more personal computers, mobile computing devices such as personal digital assistants (PDAs), tablets, and smartphones, handheld gaming devices, wearable devices, tablet computers, routers, switches, voice gates, servers, electronic storage devices, imaging devices, media players, and/or other networked-enabled tools that may perform a mechanical or other function. These network devices may be interconnected through wired, wireless, optical, and other appropriate communication links.

In addition, client electronic devices 410 and 412 and/or a client smart device 414, may connect to network 402. Each of these devices is an example of data processing system 300, described above regarding FIG. 3. Client electronic devices 410, 412, and 414 may include, for example, one or more personal computers, network computers, and/or mobile computing devices such as personal digital assistants (PDAs), smart phones, handheld gaming devices, wearable devices, and/or tablet computers, and the like. In the depicted example, server 404 provides information, such as boot files, operating system images, and applications to one or more of client electronic devices 410, 412, and 414. Client electronic devices 410, 412, and 414 may be referred to as “clients” in the context of their relationship to a server such as server computer 404. Client devices may be in communication with one or more client data store(s) 420, which may be employed to store information local to the clients (e,g., cookie(s) and/or associated contextual information). Network data processing system 400 may include more or fewer servers and/or clients (or no servers or clients), as well as other devices not shown.

In some examples, first client electric device 410 may transfer an encoded file to server 404. Server 404 can store the file, decode the file, and/or transmit the file to second client electric device 412. In some examples, first client electric device 410 may transfer an uncompressed file to server 404 and server 404 may compress the file. In some examples, server 404 may encode text, audio, and/or video information, and transmit the information via network 402 to one or more clients.

Client smart device 414 may include any suitable portable electronic device capable of wireless communications and execution of software, such as a smartphone or a tablet. Generally speaking, the term “smartphone” may describe any suitable portable electronic device configured to perform functions of a computer, typically having a touchscreen interface, Internet access, and an operating system capable of running downloaded applications. In addition to making phone calls (e.g., over a cellular network), smartphones may be capable of sending and receiving emails, texts, and multimedia messages, accessing the Internet, and/or functioning as a web browser. Smart devices (e.g., smartphones) may also include features of other known electronic devices, such as a media player, personal digital assistant, digital camera, video camera, and/or global positioning system. Smart devices (e.g., smartphones) may be capable of connecting with other smart devices, computers, or electronic devices wirelessly, such as through near field communications (NFC), BLUETOOTH®, WiFi, or mobile broadband networks. Wireless connectively may be established among smart devices, smartphones, computers, and/or other devices to form a mobile network where information can be exchanged.

Data and program code located in system 400 may be stored in or on a computer-readable storage medium, such as network-connected storage device 408 and/or a persistent storage 308 of one of the network computers, as described above, and may be downloaded to a data processing system or other device for use. For example, program code may be stored on a computer-readable storage medium on server computer 404 and downloaded to client 410 over network 402, for use on client 410. In some examples, client data store 420 and server data store 422 reside on one or more storage devices 408 and/or 308.

Network data processing system 400 may be implemented as one or more of different types of networks. For example, system 400 may include an intranet, a local area network (LAN), a wide area network (WAN), or a personal area network (PAN). In some examples, network data processing system 400 includes the Internet, with network 402 representing a worldwide collection of networks and gateways that use the transmission control protocol/Internet protocol (TCP/IP) suite of protocols to communicate with one another. At the heart of the Internet is a backbone of high-speed data communication lines between major nodes or host computers. Thousands of commercial, governmental, educational and other computer systems may be utilized to route data and messages. In some examples, network 402 may be referred to as a “cloud.” In those examples, each server 404 may be referred to as a cloud computing node, and client electronic devices may be referred to as cloud consumers, or the like. FIG. 4 is intended as an example, and not as an architectural limitation for any illustrative embodiments.

### D. Illustrative Combinations and Additional Examples

This section describes additional aspects and features of an income estimation method, presented without limitation as a series of paragraphs, some or all of which may be alphanumerically designated for clarity and efficiency. Each of these paragraphs can be combined with one or more other paragraphs, and/or with disclosure from elsewhere in this application, in any suitable manner. Some of the paragraphs below expressly refer to and further limit other paragraphs, providing without limitation examples of some of the suitable combinations.

A0. A computer-implemented method, the method comprising:

determining, from one or more data sources, a set of property features including amenities of a target property;

determining a location of the target property based on the set of property features;

utilizing the location of the target property to infer a set of geographic features associated with the location;

identifying other properties having similar amenities and geographic features as the target property; and

estimating an expected rental income of the target property based on historical rental data of the identified other properties.

A1. The method of A0, wherein determining the set of property features of the target property includes utilizing a semantic analysis model to infer one or more of the amenities from the one or more data sources.

A2. The method of A1, wherein the semantic analysis model comprises a skip-gram model.

A3. The method of any one of paragraphs A0 through A2, wherein determining the set of property features of the target property further includes utilizing an image recognition model to one or more of the amenities from the one or more data sources.

A4. The method of A3, wherein the image recognition model comprises a random forest model.

A5. The method of any one of paragraphs A0 through A4, wherein estimating the expected rental income of the target property includes estimating an occupancy and an average daily rate based on the historical rental data.

A6. The method of any one of paragraphs A0 through A5, wherein determining the set of geographic features includes determining a geographic density of places of interest within a region around the location.

A7. The method of A6, wherein the places of interest include restaurants, bars, parks, and stores.

A8. The method of any one of paragraphs A0 through A7, wherein determining the location of the target property further includes utilizing a natural language processing (NLP) model to infer the location from the one or more data sources.

A9. The method of any one of paragraphs A0 through A8, wherein determining the location of the target property further includes searching one or more secondary data sources for a candidate property having a similar set of amenities as the target property.

B0. A data processing system, comprising:

one or more processors;

a memory;

a software program configured to estimate an expected short-term rental income of a target property, the software program including a plurality of instructions executable by the one or more processors to:
determine, from one or more data sources, a set of property features including amenities of the target property;
determine a location of the target property based on the set of property features;
utilize the location of the target property to infer a set of geographic features associated with the location;
identify other properties having similar amenities and geographic features as the target property; and
estimate the expected rental income of the target property based on historical rental data of the identified other properties.

B1. The system of B0, wherein determining the set of property features of the target property includes utilizing a semantic analysis model to infer one or more of the amenities from the one or more data sources.

B2. The system of B1, wherein the semantic analysis model comprises a skip-gram model.

B3. The system of any one of paragraphs B0 through B2, wherein determining the set of property features of the target property further includes utilizing an image recognition model to one or more of the amenities from the one or more data sources.

B4. The system of B3, wherein the image recognition model comprises a random forest model.

B5. The system of any one of paragraphs B0 through B4, wherein estimating the expected rental income of the target property includes estimating an occupancy and an average daily rate based on the historical rental data.

B6. The system of any one of paragraphs B0 through B5, wherein determining the set of geographic features includes determining a geographic density of places of interest within a region around the location.

B7. The system of B6, wherein the places of interest include restaurants, bars, parks, and stores.

B8. The system of any one of paragraphs B0 through B7, wherein determining the location of the target property further includes utilizing a natural language processing (NLP) model to infer the location from the one or more data sources.

B9. The system of any one of paragraphs B0 through B8, wherein determining the location of the target property further includes searching one or more secondary data sources for a candidate property having a similar set of amenities as the target property.

### Advantages, Features, and Benefits

The different embodiments and examples of the income estimation method described herein provide several advantages over known solutions for estimating the income of a property on the short-term rental market. For example, illustrative embodiments and examples described herein allow for income estimation of a property utilizing only data available from public sources.

Additionally, and among other benefits, illustrative embodiments and examples described herein allow for inferencing the location of a property such that geographic features of the property may be analyzed.

Additionally, and among other benefits, illustrative embodiments and examples described herein allow the geographic features of a region to be categorized such that a vacation score may be attributed the region.

Additionally, and among other benefits, illustrative embodiment and examples described herein allow the prediction of revenue from a cross-platform marketing approach, dynamic price-setting, and both professionally and individually managed properties.

No known system or device can perform these functions. However, not all embodiments and examples described herein provide the same advantages or the same degree of advantage.

### CONCLUSION

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A computer-implemented method, the method comprising:
determining, from one or more data sources, a set of property features including amenities of a target property;
determining a location of the target property based on the set of property features;
utilizing the location of the target property to infer a set of geographic features associated with the location;
identifying other properties having similar amenities and geographic features as the target property; and
estimating an expected rental income of the target property based on historical rental data of the identified other properties.

2. The method of claim 1, wherein determining the set of property features of the target property includes utilizing a semantic analysis model to infer one or more of the amenities from the one or more data sources.

3. The method of claim 2, wherein the semantic analysis model comprises a skip-gram model.

4. The method of claim 1, wherein determining the set of property features of the target property further includes utilizing an image recognition model to one or more of the amenities from the one or more data sources.

5. The method of claim 4, wherein the image recognition model comprises a random forest model.

6. The method of claim 1, wherein estimating the expected rental income of the target property includes estimating an occupancy and an average daily rate based on the historical rental data.

7. The method of claim 1, wherein determining the set of geographic features includes determining a geographic density of places of interest within a region around the location.

8. The method of claim 7, wherein the places of interest include restaurants, bars, parks, and stores.

9. The method of claim 1, wherein determining the location of the target property further includes utilizing a natural language processing (NLP) model to infer the location from the one or more data sources.

10. The method of claim 1, wherein determining the location of the target property further includes searching one or more secondary data sources for a candidate property having a similar set of amenities as the target property.

11. A data processing system, comprising:
one or more processors;
a memory;
a software program configured to estimate an expected short-term rental income of a target property, the software program including a plurality of instructions executable by the one or more processors to:
determine, from one or more data sources, a set of property features including amenities of the target property;
determine a location of the target property based on the set of property features;
utilize the location of the target property to infer a set of geographic features associated with the location;
identify other properties having similar amenities and geographic features as the target property; and
estimate the expected rental income of the target property based on historical rental data of the identified other properties.

12. The system of claim 11, wherein determining the set of property features of the target property includes utilizing a semantic analysis model to infer one or more of the amenities from the one or more data sources.

13. The system of claim 12, wherein the semantic analysis model comprises a skip-gram model.

14. The system of claim 11, wherein determining the set of property features of the target property further includes utilizing an image recognition model to one or more of the amenities from the one or more data sources.

15. The system of claim 14, wherein the image recognition model comprises a random forest model.

16. The system of claim 11, wherein estimating the expected rental income of the target property includes estimating an occupancy and an average daily rate based on the historical rental data.

17. The system of claim 11, wherein determining the set of geographic features includes determining a geographic density of places of interest within a region around the location.

18. The system of claim 17, wherein the places of interest include restaurants, bars, parks, and stores.

19. The system of claim 11, wherein determining the location of the target property further includes utilizing a natural language processing (NLP) model to infer the location from the one or more data sources.

20. The system of claim 11, wherein determining the location of the target property further includes searching one or more secondary data sources for a candidate property having a similar set of amenities as the target property.
